(19) United States
(12) Patent Application Publication
(10) Pub. No.: US 2015/0254918 A1
(43) Pub. Date: Sep. 10, 2015

(54) System, process, or method for the use of cross-inhibitive-voting in collaborative societal decision making within social networks

(71) Applicant: Jeffrey F. Miller, Los Gatos, CA (US)

(72) Inventor: Jeffrey F. Miller, Los Gatos, CA (US)

(21) Appl. No.: 14/201,672

(22) Filed: Mar. 7, 2014

(51) Int. Cl. G07C 13/00

(52) U.S. Cl. CPC G07C 13/00; G06Q 2230/00

(57) ABSTRACT

As uses of interne based social networks have become broader, the potential for collaborative interaction has remained restricted by the effectiveness of voting methods. The application of cross-inhibitive-voting in social networks enables improved quality in the outcome of voting processes, and inclusion of greater numbers of voters by employing repetitive voting, quorum detection, reciprocal-time-weighting of votes, and the determination of a single best-of-N, or top-x-of-N ranking of alternatives determined by the number of in-favor votes minus the number of in-opposition votes.

### CROSS-REFERENCE TO RELATED APPLICATIONS

The present invention claims the benefit of a prior non-provisional application entitled: “A system, process, or method for creation, propagation and use of dynamic fractional proxy in collaborative societal decision making within social networks”, application #13787804, filing date 7 Mar. 2013. The first sentence following the title is: “The present invention relates generally to social networking, and more particularly to systems, processes or methods of voting and expression of preference in social collaborations.”

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Endeavor

The field of endeavor of present invention relates generally to social networking, and more particularly to systems, processes or methods of voting, vote casting, and expression of preference in social collaborations in which decisions are made.

The information processing capabilities of a society are the bounding conditions within which all tradeoffs between the capacity and quality of decision making take place. Practical limitation of time and space upon information processing has historically hindered the effectiveness of collaborative decision-making and necessitated compromise to accommodate greater numbers of individuals, and to increase decision making capacity of collaborative processes.

The potential of social networks to enable more productive collaborative interaction has not been realized in part because of the dearth of electoral processes capable of maximizing the quality of electoral processes for effective collaboration within large participating populations.

2. State of the Art

Social structures are the means by which humans combine efforts, expertise and knowledge to provide quality solutions to shared problems or to exploit opportunities. Current voting methods employed within social networks are insufficient to realize the potential of social network based collaborative decision making. The basis of democratic electoral processes employed for societal collaboration is the principal of one-person one-vote, in which each member of society holds a natural right to a single vote, herein referred to as a single whole natural vote. The casting of a single whole natural vote as a positive indicator of preference is considered state of the art and manifest in social networks as either opportunistic or solicited voting opportunities.

Polling or surveying are a solicitations done in the context of social networks are employed to characterize preference of individuals or groups of individuals, and solicitations of preference are used by social networks administrators to invoke a greater sense of user belonging to the social network, and to attract and retain users.

Opportunistic expression of preference by voting is most often employed in a social network in the context of a specific event in which individuals are offered one or a few categorical choices. In practice, opportunistic voting had been in the form of a “Like” feature in which an individual user is given the opportunity to endorse another user, or to create a recommendation or endorsement.

Both opportunistic and solicited voting within social networks are expressions of preference by in-favor voting. Voting methodologies of social networks have, heretofore, not employed methods for the voting of negative preference, the absence of which has resulting in compromises to electoral quality, including:

### Vulnerability to Tactical Voting

Single pass voting processes of the type currently employed within social networks are vulnerable to tactical or insincere voting of participants.
   Few Categorical Options from which to Choose
Selection between a few solutions which tend to be categorical in character, are common restriction of the type of electoral processes employed within social networks.

### Low Participation Vulnerability

Single pass voting processes within social networks can produce poor quality outcomes when low numbers of participants vote.

### Ambiguity of Negative Preference Expression

The type of electoral processes employed within social networks employing positive feedback in-favor voting without also using in-opposition voting, are unable to distinguish negative preference from voter apathy or other non participatory behavior.

### Insufficient Voter Knowledge

Single pass voting processes within social networks are limited in quality by participant's lack of knowledge of all available alternatives when more than a few alternatives are available, or when available alternatives are complex.

### Long Deadlock Resolution

Deadlock conditions, when occurring in single pass voting processes currently employed within social networks, require long times to resolve.

### BRIEF SUMMARY OF THE INVENTION

Cross-inhibitive voting is the use of negative preference in electoral processes of collective decision making. The option of individual exercise of cross-inhibitive voting as an expression of negative preference, when combined with in-favor voting, results in a more complete representation of preference, and enables more effective electoral processes. When applied to collaborative societal decision making, use of cross-inhibitive voting enables adaptation to participation by large population of voters to complex issues, and to large numbers of alternatives.

Eusocial collaborative decision making systems are the product of competitive selection and millions of year of evolutionary refinement. The present invention provides an improvement upon historic voting methods as applied within the context of social networking, and enables voting methods which more closely approach optimal voting efficiencies attributed to collective decision making methods of eusocial biological systems.

The use of cross-inhibitive-voting, when applied to collaborative decision making within social networks, more closely approaches optimal selection of a best-of-N, or top-x-of-N ranking, than other voting methods while increasing quality and reliability of the electoral process through the:
rapid resolution of deadlock conditions,
incremental tradeoff between speed and accuracy,
reduction of the influence of variability (signal noise) across heterogeneous voting populations,
accommodation of simultaneous processing of widely scattered information by a plurality of participants,
lack of direct knowledge of all alternatives by each participant is not restrictive to outcome quality,
resistant to electoral truncation (exclusion of alternatives),
and is adaptive to low voter participation levels.

### BRIEF DESCRIPTION OF DRAWINGS

FIG. 1 flow depicting an electoral event in which cross-inhibitive-voting may be used

FIG. 2 flow depicting the casting of votes using cross-inhibitive-voting

### DETAILED DESCRIPTION

It will be appreciated that the system, process or method may vary as to configuration and as to details of the constituent elements of the present invention, and that the system, process, or method may vary as to the specific steps and sequence, without departing from the basic concepts as disclosed herein.

### SPECIFICATION BACKGROUND

Social networks in the context of the present invention described herein, are any kind of social relationships or associations between a plurality of people, groups of people, companies, or programmable agent apparatus, collectively referred to as associated entities, and which may be represented by a plurality of nodes connected by a plurality of labeled edges through which information may flow, and which may employ a device, such as a computer, smart phone, interactive television or personal communications or computing device, to establish and maintain a presence in a social network. In addition, the term social network as used herein shall include the greater collective context of social interaction within or among disparate social networks through and between which information may flow and social relationships or associations may occur.

The present invention applies to social networks where associated entities have a business relationship, a friendship, or any other type of association such as vendor/vendee relationships, political affiliations or shared hobbies, occupation, geography, citizenship, nationality, or academic endeavors. In the context of an electoral event any of these associated entities may be referred to as a participant or a participating entity.

An electoral event referred to herein, is any social or societal interaction taking place in a social network in which participant entities have an opportunity or obligation to vote as an expression of preference intended to produce a single best-of-N electoral outcome, or a top-x-of-N ranking. Herein such an electoral event is facilitated by a neutral, fair, and impartial, nonvoting, sentient entity which is present in or connected to a social network, which herein is referred to as an electoral authority.

A voting-weight-right consists, at minimum, of a single whole natural vote of a participating entity, and may include accumulated proxy. Thus a voting-weight-right may exceed the weight of a single whole natural vote. The terms “votes”, the plural case as used herein, refers to fractional vote weights cast upon more than one electoral option. The term “vote”, referring to the singular case, may be comprised of any fractional division of a voting-weight-right, as cast upon a single electoral option.

Voting in the context of an electoral event is the casting of a vote or votes as an expression of preference or contra-preference by a participating entity which imparts influence upon the outcome of an electoral event. The casting of votes is a single act of voting in the context of an electoral event in which full or fractional divisions of voting weight are cast upon one or more electoral choice.

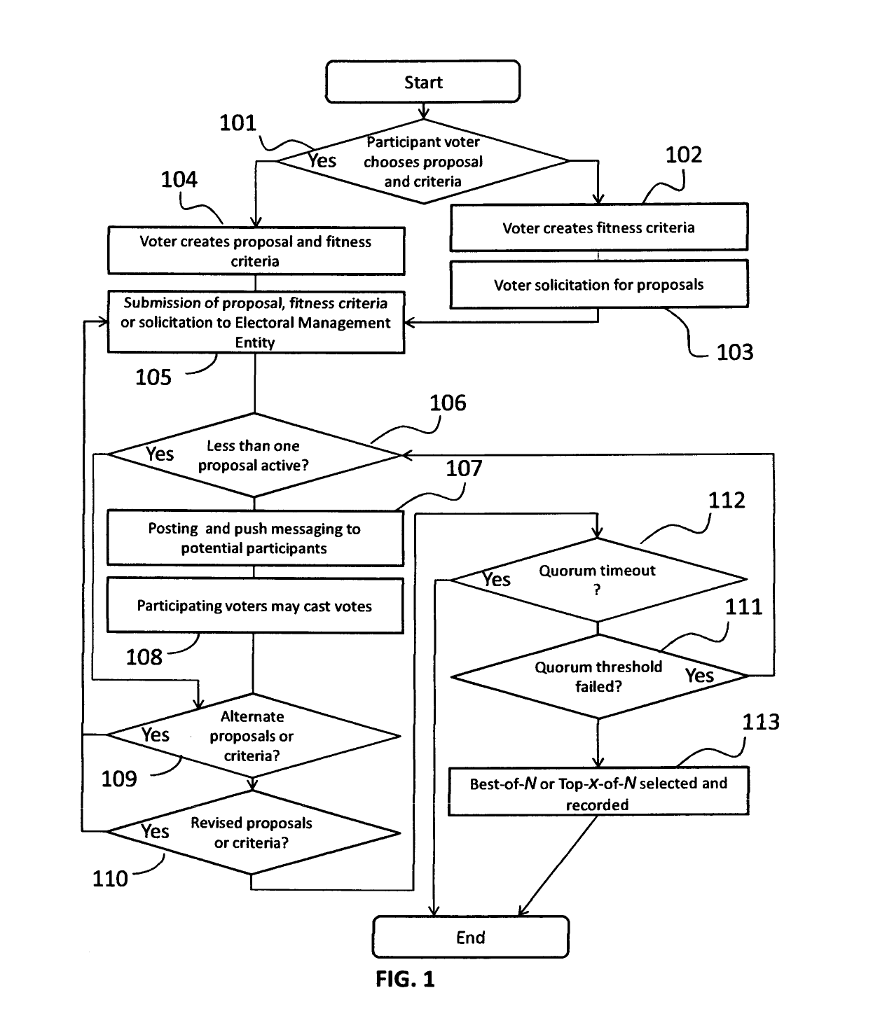

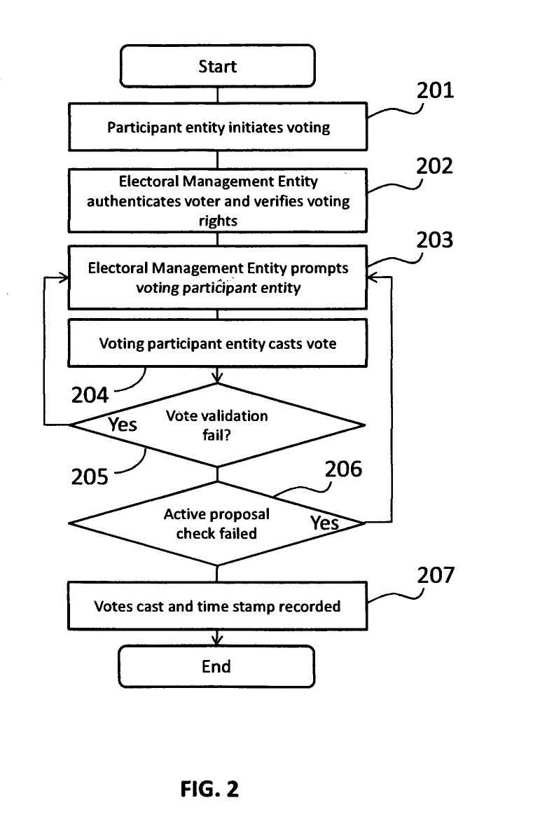

Referring more specifically to the drawings, for illustrative purposes the present invention may be understood in the exemplary system, process or method generally portrayed in FIGS. 1 and 2.

Simplified Flow Depicting an Electoral Event in which Cross-Inhibitive-Voting May be Used

The exemplary simplified flow of FIG. 1 is a preferred embodiment of an electoral event within a social network in which cross-inhibitive-voting may be employed, and depicts a repetitive flow which includes the creation of proposals by participant entities, the voting by participant entities, vote accumulation, the determination of quorum, and selection of a single best-of-N or top-x-of-N proposal. The flow is applicable to the simultaneous participation by a plurality of participant voting entities.

In the context of the present invention, a proposal is an electoral choice created by a participating entity and offered as a candidate for selection in an electoral event. In the exemplary preferred embodiments of the present invention offered herein, each proposal is associated with fitness criteria, which may also be referred to as criteria, by which the participant offering the proposal intends the proposal's fitness to be judged.

The flow begins with a participant entity choosing 101 either; a) to create a proposal and fitness criteria, or b) create a set of fitness criteria with an accompanying solicitation to other participants for proposals with potential for meeting in some degree the fitness criteria accompanying the solicitation.

If that participant chooses the latter, the flow of FIG. 1 depicts that participant's action of producing fitness criteria 102, solicitation for proposals, 103 and submission to an electoral-management-entity 105. If however the participant chooses the former, then the flow depicts the participant creation of a proposal and a set of associated fitness criteria, 104 and the submission of same to an electoral-management-entity 105.

An electoral-management-entity is an instrument of an electoral authority present in a social network, and which functions include but are not limited to; serving as a repository for the collection of proposals, solicitations and fitness criteria, the facilitation of voting, determination of quorum, and identification of an electoral winner, or ranked electoral winners.

In the example flow of FIG. 1 following the creation of criteria and proposal or solicitation, those criteria, proposals or solicitations are submitted 105 to an electoral-management-entity. If during any repetition of the flow there are no active proposals 106, the flow remains receptive to alternate proposals 109 or revision of prior posting of proposals and criteria 110, including inactivation or reactivation of proposals.

If one or more proposals are active 106, the electoral-management-entity posts 107 within the social network, the content of all active proposals, solicitations and associated fitness criteria, present value of cumulative votes associated with each proposal, and initiates push communication to entities within or external to a social network. Following posting and push communications, any participating entity wishing to, may cast a vote 108 upon any or all active proposals.

Subsequent to voting 108, any participating entity may choose to initiate an alternative or competing proposal with associated fitness criteria 109 by submitting such to the electoral-management-entity. Any proposal or criteria may be revised, and any proposal inactivated or reactivated 110 by the originating participant entity at any time during the electoral event. Any vote weight accumulated by a proposal is reset to an initial value upon reactivation.

In this manner, the exemplary simplified flow of FIG. 1 depicts a continuous process accommodating proposal introduction, voting, proposal and criteria revision, competing proposal introduction, and repetitive voting so long as there are active proposals and voting participants until a quorum condition is achieved.

### Quorum Threshold Determination

In addition to the continuous process described, FIG. 1 also depicts quorum threshold determination 111, and quorum timeout 112 by which the flow terminates if no quorum threshold is detected within the period dictated by the quorum timeout.

The presence of a quorum timeout function is intended to remove infinite repetition from the set of conditions of which the flow is capable. In an exemplary preferred embodiment the timeout value is envisioned to be two orders of magnitude or greater than the period statistically determined for the flow to resolve to a quorum condition.

The conditions on which a quorum threshold is achieved may be many and varied, and which may include but are not limited to; the initial values, present values, peak values, and rates of change of one or more of: the number of potential participating entities in a population, the number of entities participating in an electoral event, the total votes cast in the electoral event, number of vote casting events, the number of active proposals, the sum of reciprocal-time-weighted-votes for any or all active proposals, or the rates of repetitive voting.

For example, as envisioned in the simplified exemplary depiction, the function determining achievement of quorum threshold is participation of a fixed proportion of the number of potential participating entities in a population.

At the point in time at which a quorum threshold is achieved, additional voting is disallowed and the electoral-management-entity determines and publically posts 113 the single best-of-N, or top-x-of-N ranked proposal where x is a number less than the number of proposals active upon achievement of a quorum condition.

### Simplified Flow Depicting the Casting of Votes Using Cross-Inhibitive-Voting

FIG. 2 provides an exemplary simplified system, process or method flow for the casting of votes within the context of a social network by a participant entity employing cross-inhibitive-voting. The flow is initiated by a voting participant entity 201, subsequent to which the electoral-management-entity authenticates the identity of the participating entity and verifies that entity's voting-weight-right 202.

Following authentication of identity and verification of voting-weight-right, the electoral-management-entity prompts that participant entity 203 with voting choices specific to that electoral event which include, but are not limited to, particulars of all active proposals and that participant's voting-weight-right. In response to prompting, that participant entity may cast 204 whole or fractional in-favor votes, or cross-inhibitive votes in-opposition upon one, or each of multiple active proposals.

The electoral-management-entity then validates 205 the casting votes by that participant entity if the sum of the absolute values of that participant's votes in that casting of votes do not exceed that participant's voting-weight-right. If vote casting validation fails, the electoral-management-entity re-prompts that participant entity to reissue a valid vote.

A test of active status of those proposals receiving a participant entity's vote is conducted 206 prior to the recording of votes cast to preclude the condition in which a proposal is rendered inactive in the time between voting and the recording of votes. If the test for active proposal status fails, the electoral-management-entity re-prompts that voting participant to reissue votes amongst active proposals.

Following the confirmation of an active status of each proposal for which a participant entity has cast votes, the time of that vote casting, referred to as a “time stamp”, is recorded 207 with that participant's votes, and that voting flow ends.

### Reciprocal-Time-Weighted Vote Determination

Upon the recording of validated vote or votes, the recorded weights are the full weight of each vote cast. However, with the passage of time the weight of those votes cast decline. The function governing the decline in vote weight over time may encompass any time based algorithm. In an exemplary preferred embodiment, the elapsed time by which a vote weight declines to half its initial value, the vote's “half life”, is not greater than one order of magnitude less than the time statistically determined for the electoral event to resolve to a quorum condition.

Each vote casting participant entity may re-cast votes at any time during an electoral event prior to a quorum condition, thus the value of cumulative votes of all voters for a particular proposal at a specific time may be interpreted as a metric of collective voter conviction for that proposal. Inherent in the exemplary flow are provisions prohibiting of automated repetitive initiation of vote casting.

While the examples of the present invention have heretofore been in the context of a preferred embodiment, the claims of the present invention are not to be construed as limited to such preferred embodiments.

### Benefits and Conclusion

The information processing capabilities of collaborative societal processes constitute the bounding conditions of electoral capabilities within which decision making takes place. The use of cross-inhibitive-voting in collaborative decision making processes constitutes a change in the bounding conditions, expanding the possible performance therein.

The performance of an electoral process encompasses both quality and reliability. Quality of an electoral process is the degree to which a set of objective criteria are met. Reliability of an electoral process in the context of the present invention is the consistency in achieving an electoral outcome of a specific quality.

The beneficial influence of cross-inhibitive-voting in social network based collaborative decision making include, but are not limited to:

### High Quality of Electoral Result

The result of an electoral process using repetitive vote casting with cross-inhibitive-vote use (a form of range voting with blanks) approaches more closely the optimal selection of a best-of-N or top-x-of-N rank, than do other methods.

### Increased Reliability

The regulating effect of cross-inhibitive-vote produced negative feedback drives deadlock conditions to resolution more rapidly that voting methods not employing negative feedback, thus more reliably producing an electoral outcome.

### Adaptive Tradeoff Between Speed and Accuracy

Use of a quorum threshold enables adaptation of electoral processes allowing an increase in outcome quality in exchange for a reduction in speed of resolution, or an increase in speed of resolution for achievement of a minimum acceptable outcome quality.

### Minimized Influence of Variability Across Heterogeneous Voting Populations

The averaging influence of repetitive vote casting and cross-inhibitive-vote use reduces the influence of variability (signal noise) across heterogeneous voting populations.

### Simultaneous Inclusion of Widely Scattered Information

Employment of repetitive vote casting with cross-inhibitive-voting accommodates simultaneous processing of widely scattered information by a plurality of participant entities not dependent on direct knowledge of all alternatives.
   More Alternatives to Choose from
An electoral process using repetitive vote casting and cross-inhibitive-vote use enables repetitive incremental refinement of multiple competing alternatives, as well as introduction of new alternative throughout the voting process, thus avoiding the restriction to a small number of alternative solutions.

### Minimum Participation Guarantee

A quorum threshold determination of outcome can vary the time to quorum resolution depending on the levels of participation, and will delay resolution to a quorum condition until sufficient participation is achieved to meet the desired outcome quality.

It will be appreciated that the present invention may employ a computer program product comprised of non transitory computer readable storage medium containing computer programming for the implementation of the claimed system, method or process, and that the term “method” alone shall include reference to system, method or process.

1. A method comprising: receiving from a device of an entity participating in an electoral event, a proposal, and fitness criteria by which the participating entity indicates the proposal's fitness may be assessed, and by which relational data constructs may be created, wherein a proposal and fitness criteria are stored in a database in association with the participant and the electoral event;
receptive to receiving from a device of an entity participating in an electoral event, fitness criteria in reference to which the participating entity intends to solicit proposals complying with the fitness criteria in some degree, and by which relational data constructs may be created, wherein the fitness criteria, referenced for solicitation of proposals, which are received, are stored in a database in association with the participant, the solicitation, and with the electoral event;
receptive to receiving from a device of an entity participating in an electoral event, a proposal in response to solicitation for proposals, and by which relational data constructs may be created, wherein a proposal received in response to a solicitation for proposals and associated fitness criteria, are stored in a database in association with the responding participant, and the electoral event;
receptive to receiving from a device of an entity participating in an electoral event, a revision of a previous proposal or fitness criteria by an originating participant, whereby upon such receipt any accumulated vote sum of a revised proposal is reset to an initial condition, and wherein any revision to a previous proposal or fitness criteria, and the resetting of associated votes sums, are stored in a database in association with the participant and the electoral event;
receiving from a device of an entity participating in an electoral event, a casting or repetitive casting of votes in-favor of, or in-opposition to, one or more proposals in which each recast vote of a participating entity supersedes that entities prior vote in its entirety, wherein the casting or repetitive recasting of votes supersede prior votes and are stored in a database in association with the participant, the proposals voted upon, and with the electoral event;
production of a time stamp for each casting or recasting of votes by any voting entity participating in an electoral event, identifying the time at which the votes cast or recast have been recorded, wherein time stamps for each valid casting or recasting of votes are stored in a database in association with the participant, the proposals voted upon, and with the electoral event;
receiving from a device of an electoral authority, a set of criteria for determination of a quorum condition, which may include but are not limited to any one or combination of; the initial values, present values, peak values, and rates of change of one or more of:
the number of potential participating entities in a population, the number of entities participating in an electoral event, the total votes cast in the electoral event, number of vote casting events, the number of active proposals, the sum of reciprocal-time-weighted-votes for any or all active proposals, or the rates of repetitive voting, wherein a set of criteria for determination of a quorum condition are stored in a database in association with the electoral event;
determination of a quorum condition causing termination of vote casting activities, wherein determination of a quorum condition initiates the determination of the outcome of an electoral event;
determination of either a single best-of-N electoral outcome, or the top-x-of-N ranking as an electoral outcome, based upon the vote sum for each active proposal at the time a quorum condition is achieved, wherein the vote sum of each active proposal, at the time a quorum condition is achieved, is defined by the following:
Vote sum ρ_{η}=[Σ_{all voters} RTW in-favor votes upon ρ_{η}]−[Σ_{all voters} RTW cross-inhibitive votes in-opposition upon ρ_{η}],
where:
ρ_{η} is the proposal for which the vote sum is calculated, and
RTW is reciprocal-time-weighted.

2. The method of claim 1, wherein participants and potential participants are associated entities in a social network.

3. The method of claim 1, wherein votes cast are invalidated if the sum of the absolute value of that participant's votes during a casting exceed that participants vote-weight-right, or if one or more proposals upon which a vote is cast are inactive prior to validation of vote or votes.

4. The method of claim 1, wherein production of reciprocal-time-weighted vote by which a reduction in vote weight is consistently governed by the passage of time, and the passage of time is determined in part by the time at which a quorum condition is achieved.
